(19) United States
(12) Patent Application Publication
(10) Pub. No.: US 2008/0160791 A1
(43) Pub. Date: Jul. 3, 2008

(54) Memory card with a slim USB connector

(76) Inventor: Hsiang-An Hsieh, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,559

(22) Filed: Mar. 21, 2007

(30) Foreign Application Priority Data
Dec. 27, 2006 (TW) 95222969

(51) Int. Cl. H01R 12/00

(52) U.S. Cl. 439/55

(57) ABSTRACT

A memory card with a slim USB connector includes a memory card and a cover. The memory card has a memory card body and a slim USB connector located on one end of the memory card body. The memory card has at least one concave portion. The cover covers the slim USB connector. There is a convex portion located on the cover that corresponds to the concave portion. The concave portion and the convex portion are embedded into each other when the memory card is connected with the cover. Thereby, the cover is firmly fastened on the memory card body and the slim USB connector. The problem of the cover easily coming off from the slim USB connector is avoided.

### BACKGROUND OF THE INVENTION

1. Field of the Invention

The present invention relates to a memory card. In particular, this invention relates to a memory card with a slim USB connector.

2. Description of the Related Art

Because silicon storage devices, such as USB portable disks and memory cards, etc, that have non-volatile memory (such as flash memory), have particular merits, including large capacity, small size, light weight, low power consumption, and high data transfer rate, etc, the storage devices have become popular with users. USB portable disks are extensively used as a periphery of personal computers for file backup, duplicate, or transfer. Memory cards are usually used in portable electronic devices, such as digital portable players, PDAs, digital still cameras, or cell phones with cameras, for storing digital multimedia files, such as digital music, pictures, and image files.

In order to apply the storage devices to both personal computers and portable electronic devices, a memory card with a slim USB connector has been developed. For example, Taiwan patent T.W. M265719 discloses a SD memory card with a USB interface, and Taiwan patent T.W. M276285 discloses a memory card with two connection interfaces.

However, in order to protect the pins of the USB connector, the memory card with a slim USB connector of the prior art has a cover that covers the USB connector. Because the cover is not firmly fastened on the end of the memory card, the cover easily comes off from the slim USB connector.

### SUMMARY OF THE INVENTION

One particular aspect of the present invention is to provide a memory card with a slim USB connector. The cover of the slim USB connector is easily installed and uninstalled, and the cover is firmly fastened on the slim USB connector.

The memory card with a slim USB connector includes a memory card having a memory card body and a slim USB connector located on one end of the memory card body, and a cover covering the slim USB connector. The memory card has at least one concave portion. There is a convex portion located on the cover that corresponds to the concave portion. The concave portion and the convex portion are embedded into each other.

The present invention utilizes the concave portion of the memory card and the convex portion of the cover that can be embedded into each other to form an embedding portion. Thereby, the cover is firmly fastened on the slim USB connector. The problem of the cover easily coming off from the slim USB connector is avoided.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an exploded perspective view of the memory card of the present invention;

FIG. 2 is another exploded perspective view of the memory card of the present invention; and

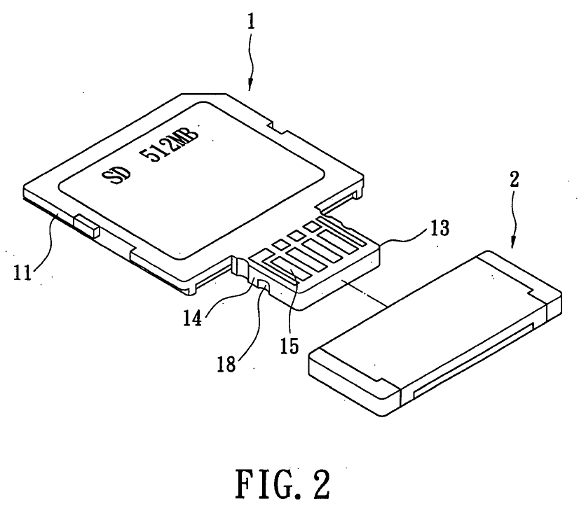

FIG. 3 is an assembly perspective view of the memory card of the present invention.

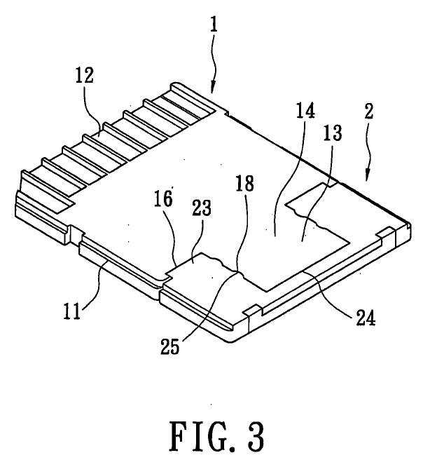

### DETAILED DESCRIPTION OF THE PREFERRED EMBODIMENTS

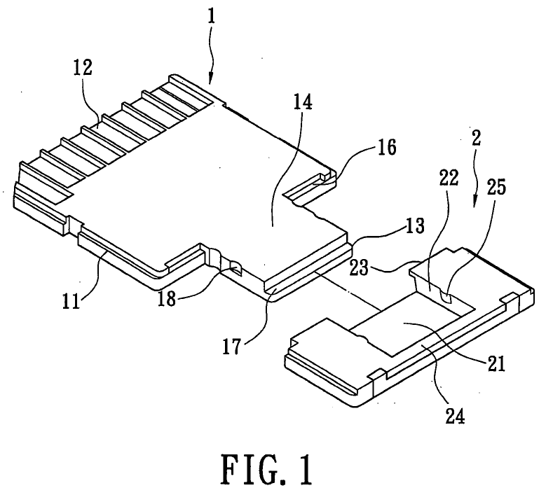

Reference is made to FIGS. 1˜3. The memory card with a slim USB connector includes a memory card 1 and a cover 2. In this embodiment, the memory card 1 is an SD memory card. The memory card 1 has a memory card body 11. The memory card body 11 has a flake shape. There is a circuit unit (not shown in the figure) in the memory card body 11. There is a plurality of memory card interface pins 12 on the memory card body 11 that match the specifications of the SD memory card. The memory card interface pins 12 are electrically connected with the circuit unit of the memory card body 11.

A slim USB connector 13 protrudes from one end of the memory card body 11. The slim USB connector 13 has a connector body 14 extending from one end of the memory card body 11. There is a plurality of USB interface pins 15 on the surface of the connector body 14. The USB interface pins 15 are electrically connected with the circuit unit of the memory card body 11.

The cover 2 is a hollow cover body that covers the slim USB connector 13. Inside the cover 2, there is a receiving space 21 for receiving the slim USB connector 13. On two sides of the receiving space 21, there is a guiding slot 22 for guiding the cover 2 to cover the slim USB connector 13.

There is a first concave portion 16 and a second concave portion 17 individually located on the memory card body 11 and the slim USB connector 13. The first concave portion 16 is a concave slot indented at the end of the memory card body 11. The second concave portion 17 is a rectangular concave slot indented at the end of the slim USB connector 13. There is a first convex portion 23 and a second convex portion 24 on the cover 2 that correspond to the first concave portion 16 and the second concave portion 17. The first convex portion 23 is a convex block protruding from the front end of the cover 2. The second convex portion 24 is a rectangular convex block protruding from the rear end of the cover 2. When the memory card 1 is connected with the cover 2, the first concave portion 16 and the second concave portion 17 are embedded with the first convex portion 23 and the second convex portion 24.

On two sides of the slim USB connector 13, there is a third concave portion 18. The third concave portions 18 are concave slots indented on the two sides of the slim USB connector 13. On the two sides of the guiding slot 22 of the cover 2, there is a third convex portion 25. The third convex portions 25 are convex blocks protruding from the two sides of the guiding slot 22. When the slim USB connector 13 is connected with the cover 2, the third concave portions 18 are embedded with the third convex portions 25.

When the memory card 1 is connected with the cover, the present invention utilizes the concave portions 16, 17 located on the memory body 11 and the end of the slim USB connector 13 and the convex portions 23, 24 located on the cover 2 to make both connect firmly. When the slim USB connector 13 is connected with the cover 2, the present invention utilizes the concave portions 18 located on two sides of the slim USB connector 13 and the convex portions 25 located on two sides of the guiding slot 22 of the cover 2 to make both connect firmly.

By utilizing the concave portions 16, 17, 18 and the convex portions 23, 24, 25 located on the memory card body 11, the slim USB connector 13, and the cover 3 to from an embedding portion and a guiding portion, the cover 2 can be firmly covered on the memory card body 11 and the slim USB connector 13. The problem of the cover easily coming off from the slim USB connector is avoided.

The description above only illustrates specific embodiments and examples of the invention. The invention should therefore cover various modifications and variations made to the herein-described structure and operations of the invention, provided they fall within the scope of the invention as defined in the following appended claims.

1. A memory card with a slim USB connector, comprising:
a memory card body having a plurality of memory card interface pins disposed adjacent a first end thereof and a connector body extending from an opposing second end of the memory card body, the connector body having a slim USB connector defined at a distal end thereof with a plurality of USB interface pins disposed adjacent the distal end, wherein the connector body has a concave portion; and
a cover for overlaying the plurality of USB interface pins, the cover having a receiving space for receiving the connector body therein, the cover having at least one convex portion protruding into the receiving space to engage the concave portion disposed in correspondence therewith when the connector body is received within the receiving space, whereby the cover is releasably secured to the connector body against inadvertent displacement therefrom.

2-3. (canceled)

4. The memory card with a slim USB connector as claimed in claim 1, wherein the memory card body includes a pair of concave slots formed in the second end thereof adjacent respective opposing sides of the connector body, and the receiving space of the cover is devoid of an enclosing wall on a bottom side thereof, the cover having a pair of convex blocks protruding from an end thereof located in correspondence to the pair of concave slots for engagement therewith.

5. The memory card with a slim USB connector as claimed in claim 1, wherein the connector body has the concave portion formed in two opposing sides thereof, and the cover has a pair of convex portions protruding into the receiving space from two opposing sides thereof.

6-7. (canceled)

8. The memory card with a slim USB connector as claimed in claim 4, wherein the connector body includes a rectangular concave slot formed in the distal end thereof, and the cover includes a rectangular convex block formed therein and protruding into the receiving space from and end thereof for engagement with the rectangular concave slot of the connector body.
